(19) United States
(12) Patent Application Publication
(10) Pub. No.: US 2011/0048121 A1
(43) Pub. Date: Mar. 3, 2011

(54) MEASURING AND READING THE SIZE OF A PARAMETER OF A REMOTELY POSITIONED DEVICE

(75) Inventor: Nicolaas van der Blom, Berkshire (GB)

(73) Assignee: NVB International UK Ltd, Windsor, Berkshire (GB)

(21) Appl. No.: 12/810,579

(22) PCT Filed: Dec. 30, 2008
(86) PCT No.: PCT/EP08/11175

§ 371 Date: Nov. 12, 2010

(30) Foreign Application Priority Data
Dec. 30, 2007 (DK) PA 200701888
Dec. 30, 2007 (DK) PA 200701891

(51) Int. Cl. B60C 23/04; F04B 53/00

(52) U.S. Cl. 73/146.3; 92/5 R

(57) ABSTRACT

A sensor-reader combination for measuring the size of a parameter of a device, the device and reader are postponed at a different physical position from each other. The measuring is done in a measuring space (19, 38, 50, 111, 130) representing said device regarding to the to be measured size of a parameter, said space is positioned nearby said reader.

### TECHNICAL FIELD

A sensor-reader combination for measuring the size of a parameter of a device, the device and reader are positioned at a different physical position from each other.

### BACKGROUND OF THE INVENTION

This invention was initiated with solutions for the problem of optimizing ergonomically the reading of a parameter such as pressure or temperature of a tyre by manual operation of a piston chamber combination, e.g. a floor pump. Current pressure gauges are positioned so far away from the user, that she or he needs to have a telescope or biniculars to enable a normal reading. As no user will use such view enhancers, many pressure gauges are being equipped with a manually rotatable pointer of a color, different from the pointer of the pressure gauge. The first mentioned pointer is pointing at the desired end pressure, and is set before the pumping session. Thereafter it is easier to assess on a distance of the difference in position of both pointers. The problem is, that end pressures of tyres normally differ from each other, and that the pointer needs to be set, mostly every time before starting the pumping. This is uncomfortable

The reason for all this, is that the pressure of a tyre in most current pumps is measured pneumatically in the hose of the pump. This prohibits the transmittal of the pneumatic information from the hose of the pump to another part of the piston-chamber combination, normally the chamber, closest to the user of the pump.

A common used solution is using a wireless (=by means of electromagnetic waves) transmission for this transmittal. It normally however means the use of electronic parts, and specifically batteries or another electric source. This is expensive, ressources demanding and change of batteries is uneasy to handle by a common user.

### OBJECT OF THE INVENTION

The object is to provide solutions for measuring a parameter, in the case that the device in which said parameter needs to be measured and said reader are on a different (or differing) distance from each other.

### SUMMARY OF THE INVENTION

In the first aspect, the invention relates to a sensor-reader combination, wherein the measuring is done in a measuring space, representing said device regarding to the to be measured the size of said parameter, said space is positioned nearby said reader.

Specifically for piston-chamber combinations, such as innovative tyre inflation pumps, where the cross sectional area's of the chamber are differing during the stroke is the size of the operating force of these pumps not anymore representing the size of the pressure in the tyre, and it is necessary to have a reliable and non-expensive pressure reading of the tyre pressure in a gauge, nearby the user during the pump stroke, e.g. nearby the handle on top of the piston rod in case of a floorpump

Obvious solutions for the transmittal of the information of a value of a parameter between parts of the combination moving relatively to each other is e.g. by an elastic wire of which each end may be connected to each part. In a pump with high pressures, will the life time of such wire being negatively affected by the harsh climate of the inside of the pump, and if not, the solution would be expensive.

Another obvious solution would be to use contacts which glide over each other during the stroke, where e.g. a contact rail would be connected to one of the moving parts, while a contact (flexible strip, or a springforce operated contact) would slide on said rail, and be connected to the other part. Not a very reliable solution in a harsh climate inside a pump. And, used in a floor pump, this would possibly prohibit the handle to rotate enough for being comfortable to pump with. This solution would be expensive as well, and not very reliable.

An obvious wireless solution is to measure e.g. the pressure in the hose of a pump, and transmit the information wireless to a receiver on the piston rod, and have a reading on a gauge on top of a handle which is operated by the user. Even this solution seems to be reliable, this solution is expensive, only already by having an electrical source on two different places.

Better solutions must be provided.

In this invention is the fact that the space of the tyre to be inflated is in direct contact with the space in the pump under the piston, during overpressure or just before balance of pressure of the pump in relation to the pressure in the tyre. That means that the size of the pressure/temperature in the tyre may be readable by measuring said parameter in the space under the piston of the pump, and in case of a high pressure pump, before the check valve, which is normally positioned between said space under the piston and the hose, which connects the pump to the valve connector, which is mounted on the tyre valve. Said space is called the measuring space. The measuring space is surrounding the bottom part of the piston rod, and thereby it may be possible to communicate by a channel (pneumaticly) or by wires (electrically) between the sensor (a pressurized spring in a manometer, òr a transducer mounted on said piston rod end or mounted on a printboard and connected by a channel to the measuring space) through said piston rod to the reader on top of the piston rod (manometer òr an electric volt/current meter òr an electronic display, respectively). Said channel is ending at said piston rod end.

In the second aspect, the invention relates to a sensor-reader combination wherein said measuring space is communicating during a part of the operation with said device.

In case of current pumps for tyre inflation, measuring of the pressure of the tyre is done in the hose of the pump. This hose is at one end connected to the chamber through a non-return valve, and at the other end connected to a valve connector. The non-return valve limits the size of the dead space of the pump. In current low pressure pumps is no non-return valve present, but no pressure gauge is normally used.

The pressure in the hose may than be representative for the pressure in the tyre, because the tyre valve closes when there is pressure equivalency between the space in the hose, and the space of the tyre. This happens in current pumps, when the piston has reached its end point after a pump stroke, and is starting to return, thus when the overpressure in the chamber drops. The reason is, that the non-return valve between the cylinder and the hose is closing as well at this point of time.

The pressure in the space of the chamber between the piston and said non-return valve may than also be representative for the tyre pressure as well, when the piston is about to return for a new stroke. This opens a solution where the pressure may be measured at the end of the piston (rod) which is adjacent the space between the piston and a non-return valve. Thus may a sensor (measuring means) and a reading means be placed on one of the parts, e.g. on the piston (rod) in a pump for tyre inflation. The sensor may be positioned on the piston rod, and best at the end of the piston rod, in order to enable place for the guiding means of the piston rod. It may then be possible to have a reading on a gauge which is positioned on top of the handle of the piston rod—thus closest to the user, and readable during operation.

E.g. in case of pressure reading: this reading may be done by a pneumatic pressure gauge, where the gauge is connected by e.g. a channel within a tube to the measuring space between the piston and the valve connector or the non-return valve. The same is valid if a temperature is being measured with a e.g. bimetal sensor. The small size of the tube and its length may give rize to dynamic friction, and may contribute to dampen the fluctuations of the pressure due to the strokes the piston is performing.

The measuring by the sensor may also be done by an electric pressure transducer, which gives through an amplifier a signal to a digital pressure gauge òr an analog pressure gauge (a volt meter or a current meter). The same is valid if a temperature is being electrically monitored. In order to make the sensor-reader combination still more profitable, the sensor may be assembled on the printboard, while the sensor is connected to the measuring space through a channel.

In the third aspect, the invention relates to a sensor-reader combination, wherein:
the size of the parameter is measured in an enclosed measuring space.

Direct measuring in the measuring space may give fluctuations of the size of the parameter, as e.g. in a piston floor pump for tyre inflation with regard to the pressure, but also with regard to the temperature. In order to simulate the pressure in the tyre within the pump, a conditioned measuring space is necessary, and this may be done by an enclosed space.

If the value of the parameter is measured in an enclosed measuring space, it is necessary to get the fluid in, measure it and read it. Thereafter get it out again for the next meassurement. E.g. in case a pressure in a tyre is measured in a floor pump, a part of the measuring space may be entered into the enclosed measuring space for enabling the measurement. This may be done by a check valve òr an electrically controlled valve. For getting the contents of the enclosed measuring space out again after the measurement, a new valve (check valve or an electrically controlled valve)—it may also be a channel, which is so tiny that dynamic friction may delay the flow out of the enclosed measuring space so much that this flow does not influence so much the measurement. This delay may be also used for the following purpose. E.g. in case of a pressure measuring in a piston-chamber combination, it may be necessary to maintain the value of the tyre pressure when the piston is returning after a pump stroke, until the value of this parameter in the space adjacent the space between the piston and a non-return valve or valve connector has reached its maximum value of the pump stroke before, by the next pump stroke. That temporary maintaining of this value may be done electronically (e.g. by the use of a condensator), by software controling an IC, by mechatronics—the position of the piston rod in relation to the pump, controlling an IC, or just by mechanics alone: e.g. an enclosed measuring space, which may be connected by a valve to the measuring space (between the piston and the valve connector, òr the space between the piston and the non-return valve between the combination and the hose in case of a pump for tyre inflation). The valve may preferably be identical with the valve between the combination and the hose, so that opening and closing happen simultaneously.

The enclosed measuring space may comprise a channel which is open in a very controlled way, so that the maximum value of the pressure may be temporarely maintained during the return of a piston during a pump stroke, simulating the pressure in the tyre. It may be a tiny channel, which connects the enclosed measuring space with the measuring space. During pumping may a very small part of the volume of the enclosed measuring space flow to the measuring space, and may influence the reading a bit, but only during the return path of the pump stroke, which is not very relevant for the reading. The flow through said tiny channel may be controlled by the dynamic friction of said channel, depending on its length, diameter and surface roughness, but also by a screw which has a tiny hole as well, e.g. in the case where the thread has been locked by a locking fluid.

When the requested pressure has been reached, will the movement of the piston stop, and will the pressure in the enclosed measuring space become equal with the pressure in the measuring space, which is the pressure of the tyre. Firstly when the hose has been disconnected from the tyre valve, the pressure in the measuring space decreases to atmospheric pressure (even there is a check valve in between), and will the pressure in the enclosed measuring space decrease to atmospheric pressure. It is necessary than to have a valve connector which is open, if no overpressure comes from the pressure source.

In order to allow the preservation of the pressure (or temperature), the measuring space comprises an outlet valve which may be initiated electrically, and which is closing the measuring space when the pumping is being initiated, and is opening after a certain short period when pumping has been done. This is only an example of a controlling arrangement. It may also be done manually, e.g. by pressing a button for closing the measuring space before the pump session, and opening up again, thereafter, by pressing said button again.

The best simulation may of course be done by a computer program, which is controlling the inlet and outlet valves, while the last mentioned are valves which may be controlled electrically/electronically. This may be done in much bigger and more costly installations, which may need maintenabce, than that of a floor pump for inflation purposes.

In case of e.g. a container (envelope) piston type (claim 5) according to EP 1179140, which uses an enclosed space, the enclosed space may be preferably positioned behind the measuring space, relative to the space adjacent the space between the piston and a non-return valve, if an electric gauge is used.

In case of a pneumatic gauge (=manometer), the enclosed space may be positioned independently of the measuring space. This may be done by a separate (measuring) channel from the measuring space to the pneumatic pressure gauge.

A piston-chamber combination comprising an elongate chamber which is bounded by an inner chamber wall and comprising a piston means in said chamber to be sealingly movable relative to said chamber at least between first and second longitudinal positions of said chamber, said chamber having cross-sections of different cross-sectional areas at the first and second longitudinal positions of said chamber and at least substantially continuously differing cross-sectional areas at intermediate longitudinal positions between the first and second longitudinal positions thereof, the cross-sectional area at the first longitudinal position being larger than the cross-sectional area at the second longitudinal position, said piston means being designed to adapt itself and said sealing means to said different cross-sectional areas of said chamber during the relative movements of said piston means from the first longitudinal position through said intermediate longitudinal positions to the second longitudinal position of said chamber, wherein the piston comprises an elastically deformable container comprising a deformable material. Said piston means may be comprising an enclosed space communicating with the deformable container (envelope), the enclosed space may have a constant volume. The container (or envelope) may be inflatable. This may be necessary when having a measuring channel or a wire loom inside the enclosed space, if the enclosed space is relatively small, like the situation is in a floor pump for tyre inflation. The circumpherential size of this piston type is that of the chamber.

A piston-chamber combination comprising an elongate chamber which is bounded by an inner chamber wall and comprising a piston in said chamber to be sealingly movable relative to said chamber wall at least between a first longitudinal position and a second longitudinal position of the chamber, said chamber having cross-sections of different cross-sectional areas and different circumferential lengths at the first and second longitudinal positions, and at least substantially continuously different cross-sectional areas and circumferential lengths at intermediate longitudinal positions between the first and second longitudinal positions, the cross-sectional area and circumferential length at said second longitudinal position being smaller than the cross-sectional area and circumferential length at said first longitudinal position, said piston comprising a which is elastically deformable thereby providing for different cross-sectional areas and circumferential lengths of the piston adapting the same to said different cross-sectional areas and different circumferential lengths of the chamber during the relative movements of the piston between the first and second longitudinal positions through said intermediate longitudinal positions of the chamber, wherein the piston is produced to have a production-size of the container in the stress-free and undeformed state thereof in which the circumferential length of the piston is approximately equivalent to the circumferential length of said chamber at said second longitudinal position, the container being expandable from its production size in a direction transversally with respect to the longitudinal direction of the chamber thereby providing for an expansion of the piston from the production size thereof during the relative movements of the piston from said second longitudinal position to said first longitudinal position. Said piston means may be comprising an enclosed space communicating with the deformable container (envelope), the enclosed space may have a constant volume.

The circumpherential size of this piston type may be that of the chamber on its smallest circumpherential size.

In case of e.g. a piston type according to claim 1 according to EP 1179140 is used, no enclosed space 42 (FIGS. 3A-C) is necessary, and also the inflation nipple 43 (FIGS. 3A-C). The enclosed space may be used then as channel 52 (FIGS. 3A-C) òr as inlet channel for the measuring space.

The check valve 43 should than be put in a reversed position.

The sensor-reader combination may be used in any device where a the sensor is remotely positioned in relation to the reading means, such as pumps, actuators, shock absorbers or motors.

The above combinations are preferably applicable to the applications.

Thus, the invention also relates to a pump for pumping a fluid, the pump comprising:
a combination according to any of the above aspects,
means for engaging the piston from a position outside the chamber,
a fluid entrance connected to the chamber and comprising a valve means, and
a fluid exit connected to the chamber.

The invention also relates to an actuator comprising:
a combination according to any of the combination aspects,
means for engaging the piston from a position outside the chamber,
means for introducing fluid into the chamber in order to displace the piston between the first and the second longitudinal positions.

The actuator may comprise a fluid entrance connected to the chamber and comprising a valve means.

Also, a fluid exit connected to the chamber and comprising a valve means may be provided.

Additionally, the actuator may comprise means for biasing the piston toward the first or second longitudinal position.

Finally, the invention relates also to a shock absorber comprising:
a combination according to any of the combination aspects,
means for engaging the piston from a position outside the chamber, wherein the engaging means have an outer position where the piston is in its first longitudinal position, and an inner position where the piston is in its second longitudinal position.

The absorber may further comprise a fluid entrance connected to the chamber and comprising a valve means.

Also, the absorber may comprise a fluid exit connected to the chamber and comprising a valve means.

### BRIEF DESCRIPTION OF THE DRAWINGS

In the following, preferred embodiments of the invention will be described with reference to the drawings wherein:

FIG. 0 shows left the combination of a pneumatic pressure/temperature gauge and a tube within the piston rod, where the measuring point is at the end of the tube, communicating with in the measuring space—the lower part of the drawing has been scaled up 2:1. A scaled up detail is also shown.
shows right the combination of a pneumatic pressure/temperature gauge and a wire loom within the piston rod, where the measuring point is at the transducer at the end of the piston rod communicating with the measuring space—the lower part of the drawing has been scaled up 2:1. A scaled up detail is also shown.

FIG. 1A shows the top of the piston rod of a floor pump with an inflatable piston with an electrical gauge mounted on top of the handle, and the bottom of the piston rod with the transducer in the enclosed measuring space.

FIG. 1B shows the bottom part of FIG. 1A on a scale 2:1.

FIG. 2A shows the top of the piston rod of a floor pump with an inflatable piston and a pneumatic gauge mounted on top of the handle, an in-between channel which ends in the enclosed measuring space.

FIG. 2B shows the bottom part of FIG. 2A on a scale 2:1.

FIG. 3A shows the top of the piston rod of a floor pump with an inflatable piston and an electrical gauge mounted on top of the handle, and the bottom of the piston rod with the transducer in an enclosed measuring space.

FIG. 3B shows the bottom part of FIG. 3A on a scale 2.5:1.

FIG. 3C shows the outlet channel of the enclosed measuring space of FIG. 3B on a scale 6:1.

FIG. 3D shows a detail of the outlet channel of FIG. 3C on a scale of 5:1.

FIG. 4 shows the bottom of an advanced floor pump for e.g. tyre inflation.

### DESCRIPTION OF PREFERRED EMBODIMENTS

FIG. 0 shows left shows a reading point 100 of a pneumatic pressure gauge housing 101. Within said gauge is a mechanical manometer 102 (not shown). The reading point 100 of the measured value of the parameter. Said gauge housing 101 is mounted on top of a piston rod 103. The piston rod 103 is hollow with channel 104, which is in the top 105 and in the bottom 106 mounting a measuring channel 107 within tube 113, which makes communication possible between the pneumatic pressure gauge 102 and the entrance 108 of channel 108 at the bottom of the tube 107. The measuring point 108 in the housing 101, at the manometer entrance. The measuring room 111. The handle 2. The suspension 109. The spring washer 6. The bolt 7. The suspension 110 of the channel 107 in the top of the piston rod 103. The suspension 112 of the piston. The tube 113.

FIG. 0 right shows a reading point 120 of a electric pressure/temperature gauge housing 121. Said housing 121 comprises an analog/digital electric gauge 122 (not shown). The reading point 120 of the measured value of said parameter. Said gauge 122 is mounted on top of a piston rod 123. The piston rod 123 is hollow with channel 124, in which a wire loom 125 is in the top 126 and in the bottom 127 is connected with a transducer 15, which is mounted on a platform 16, which makes communication possible between said gauge 121 and the measuring point 128 at the bottom of the piston rod 123. The measuring space 130. The handle 2. The spring washer 6. The bolt 7. The suspension 129 of the channel 124 in the top of the piston rod 123. The transition 22. The suspension 131 of the piston.

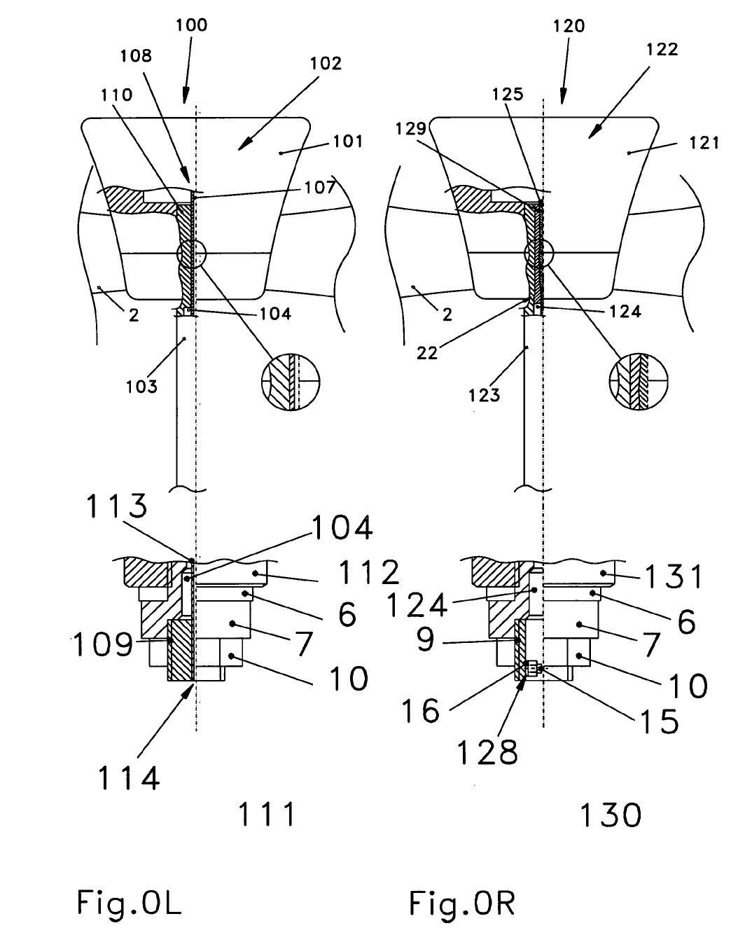

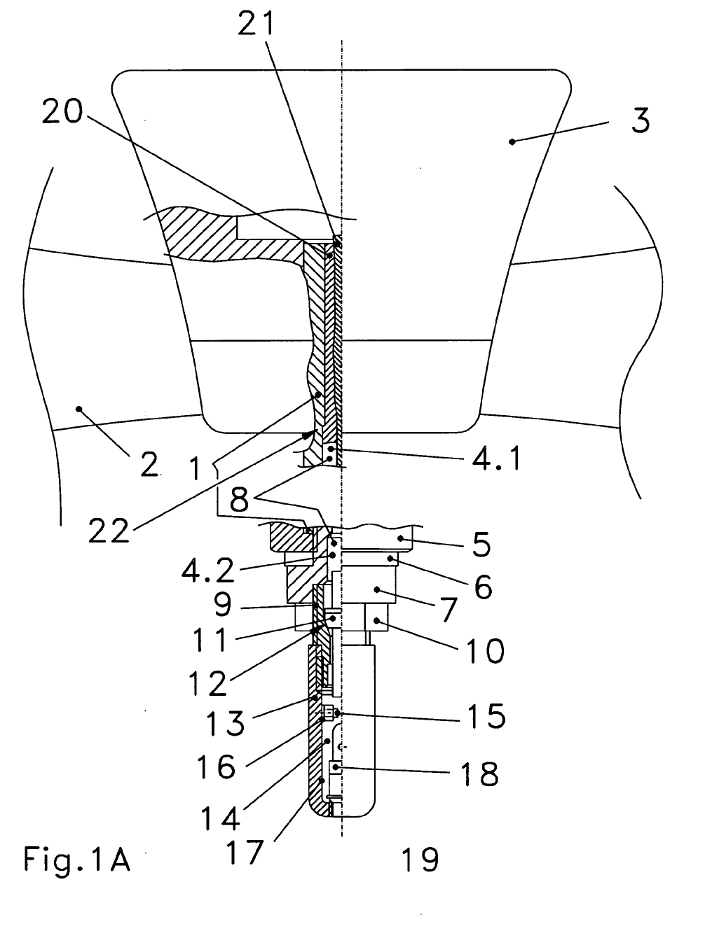

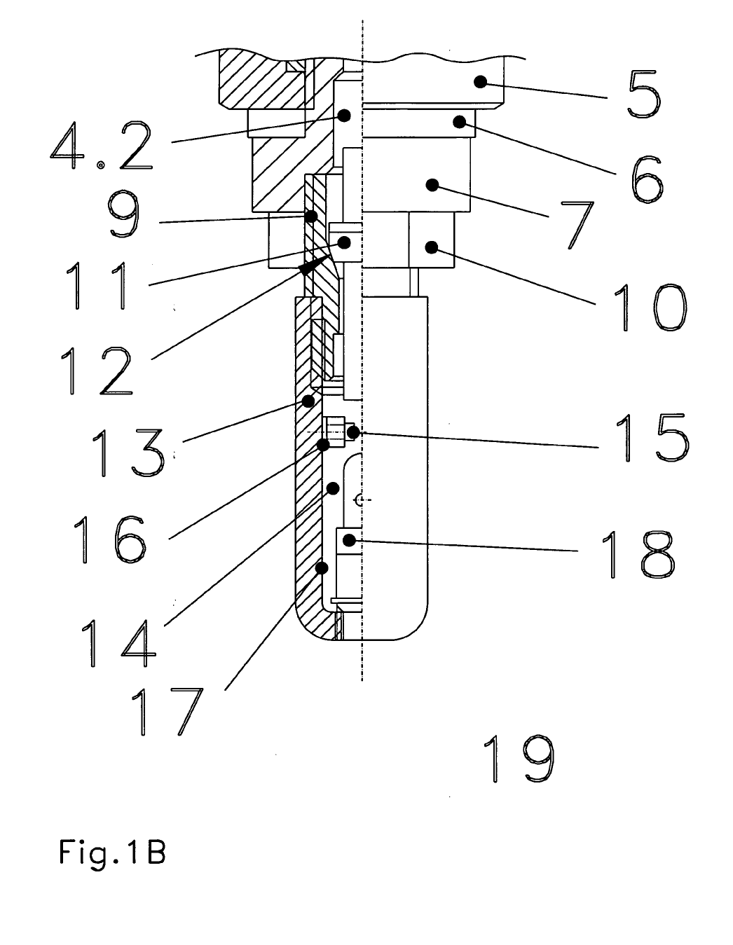

FIG. 1A shows the top of a piston rod 1 with a handle 2 and an electric (pressure/temperature) gauge 3. The gauge 3 is mounted on the handle 2. The piston rod 1 has a upper space 4.1 which is serving as an enclosed space 8 for the inflatable piston, of which only the bottom part of itssuspension 5 is shown. The spring washer 6. The top of a bold 7 is shown with the lower space of the enclosed space 8, which is directly connected to the upperspace 4.1. In the top of bold 10 is a valve body 9 mounted, and fastened by a nut 10. The core pin 11 is shown in a closed position against the stem 12 in the valve body 9. This valve 11 is serving to keep the enclosed space 8 on the necessary pressure. On the valve body 9 is the housing 13 of the enclosed measuring space 14 mounted. The (pressure) transducer 15 is shown, mounted on a platform 16. This platform 16 allows a gentle activation of the transducer 15, as the opening is between the wall 17 of the enclosed measuring space 14 and the transducer 15. The valve 18 which connects the measuring space 14 with the space 19 adjacent the outlet of the combination. The top of the hollow piston rod 1 is closed by a filler 20, which is tightly closing the necessary wire loom 21 from the pressure transducer 15 to the gauge 3. The rest of the wiring is not shown. The transition 22 prohibits the filler 20 to be burst out of the piston rod. The outlet valve of the enclosed measuring space 14 is not shown.

FIG. 1B shows the bottom part of FIG. 1A on a scale 2:1.

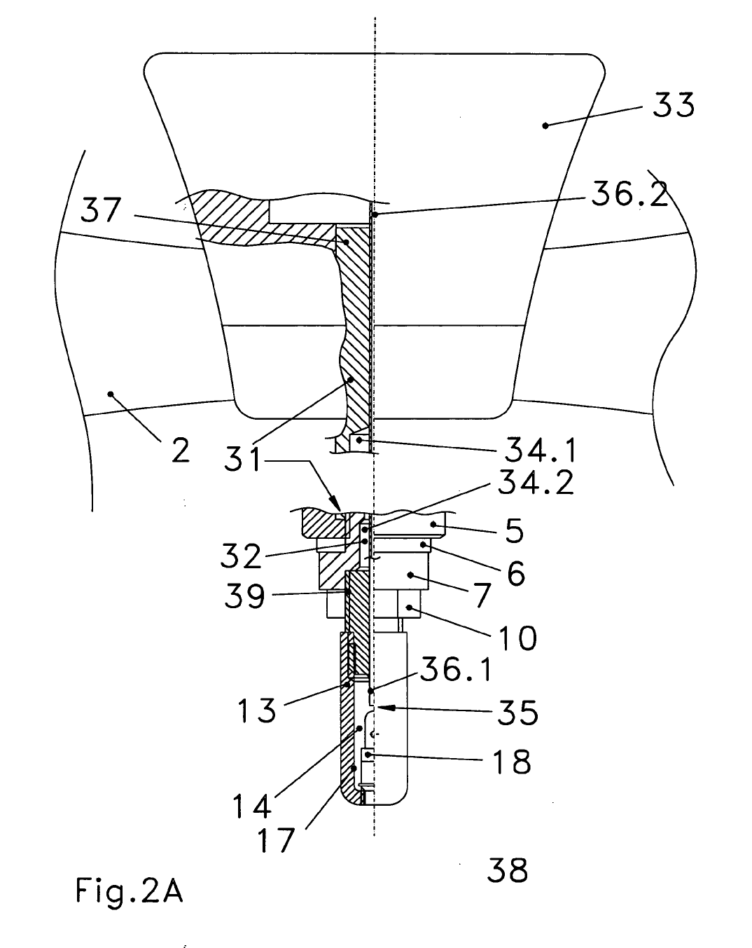

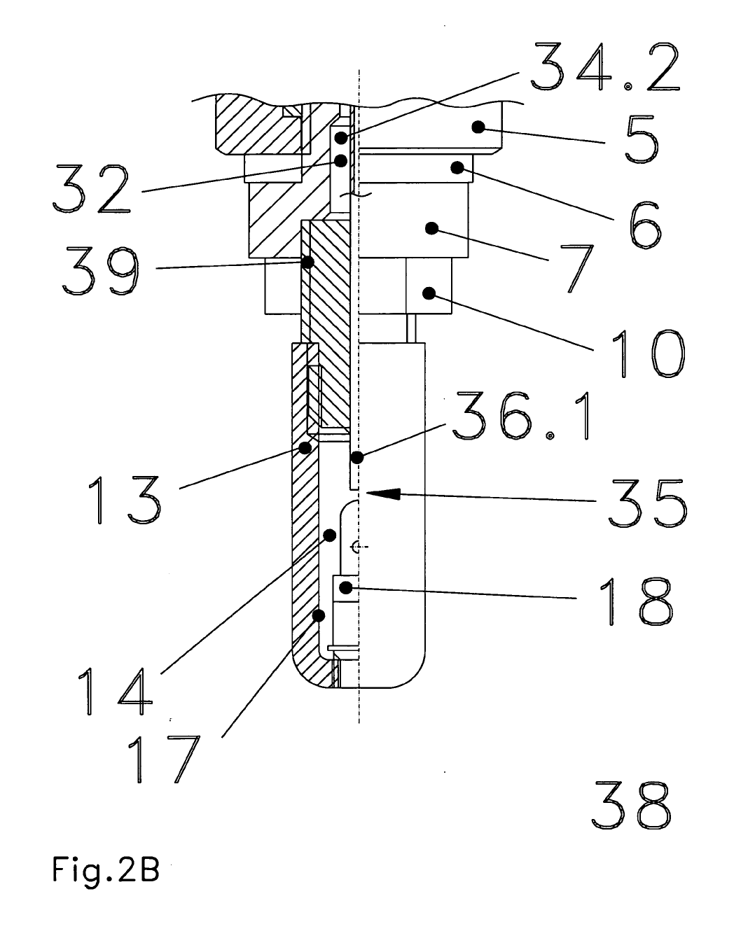

FIG. 2A shows the top of a piston rod 31 with a handle 2 and a pneumatic pressure gauge 33. Said gauge 33 is mounted on the handle 2. The piston rod 31 has a space 34.1 which is serving as an upper part of the enclosed space 32 for an inflatable piston, of which only the bottom part of its suspension 5 is shown. The spring washer 6. The top of a bold 7 is shown with part 34.2 which is serving as the lower part of the enclosed space 32, which is directly connected to the space 34.1. In the top of nut 7 is a body 39 mounted, and fastened by a nut 10. On the body 39 is the housing 13 of the enclosed measuring space 14 mounted. The end 35 of the measuring channel 36 within tube 36.2 is shown which is tightly mounted in the top 37 of the piston rod 31, and connected to the pneumatic pressure gauge. The valve 18 which connects the measuring space 14 with the space 38 adjacent the outlet of the combination. The outlet valve of the measuring space 32 is not shown.

FIG. 2B shows the bottom part of FIG. 2A on a scale 2:1.

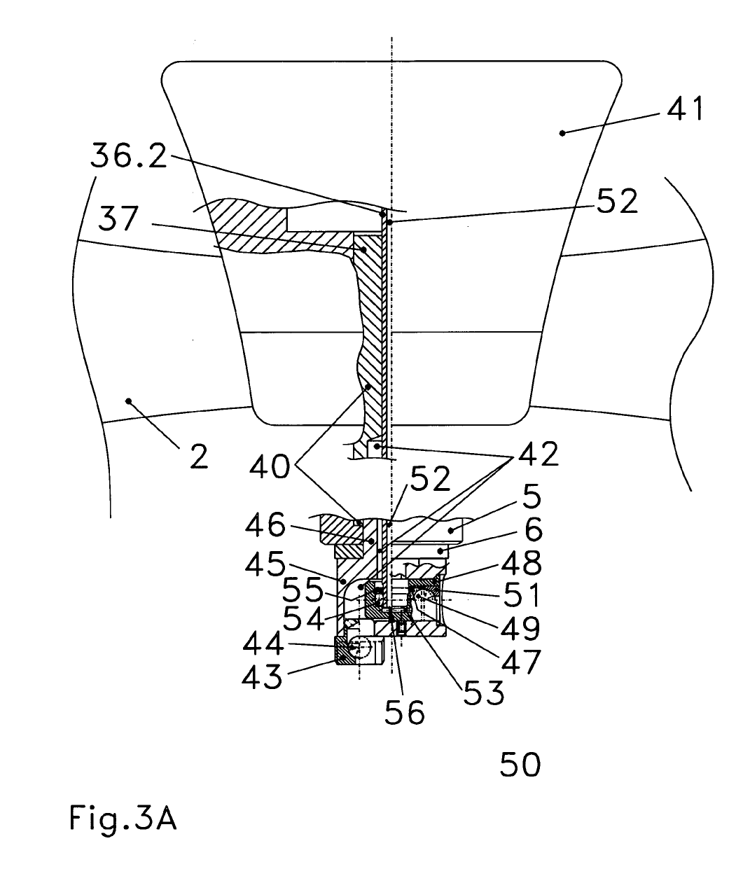

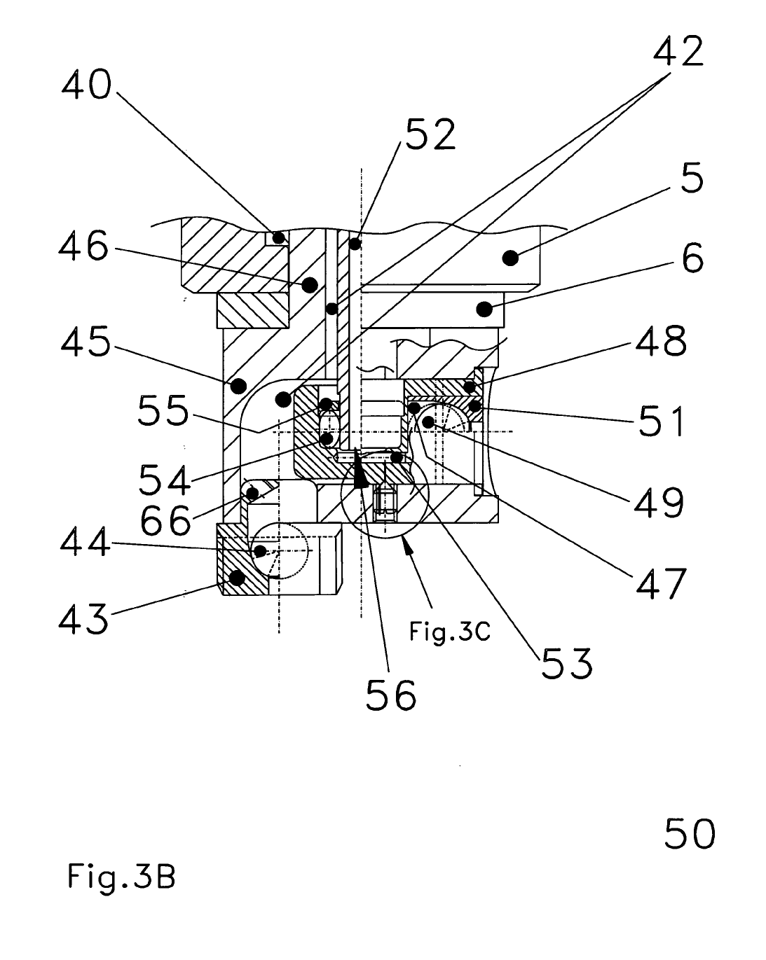

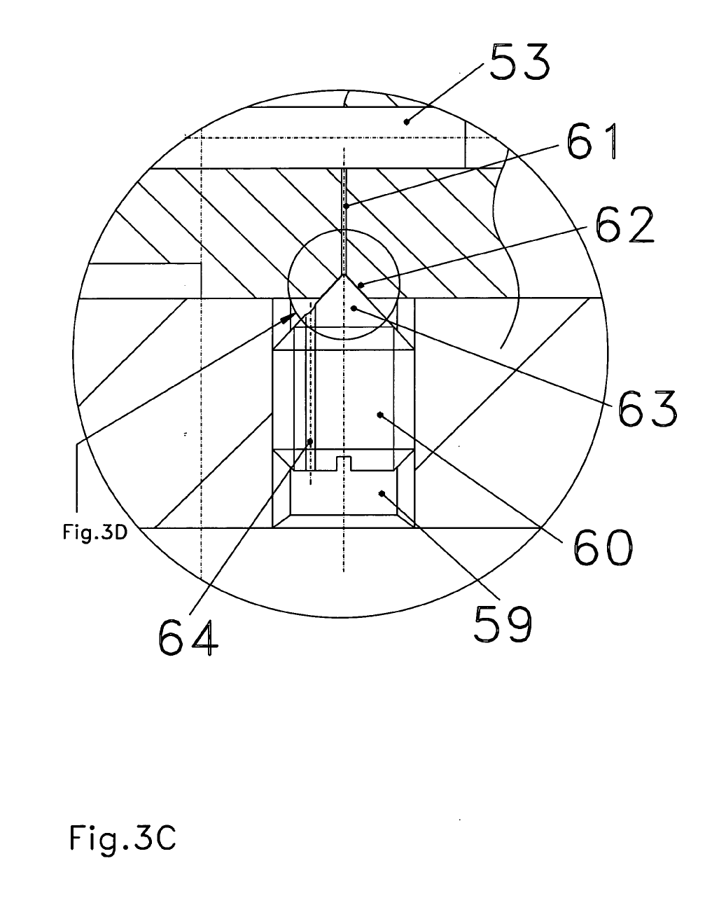

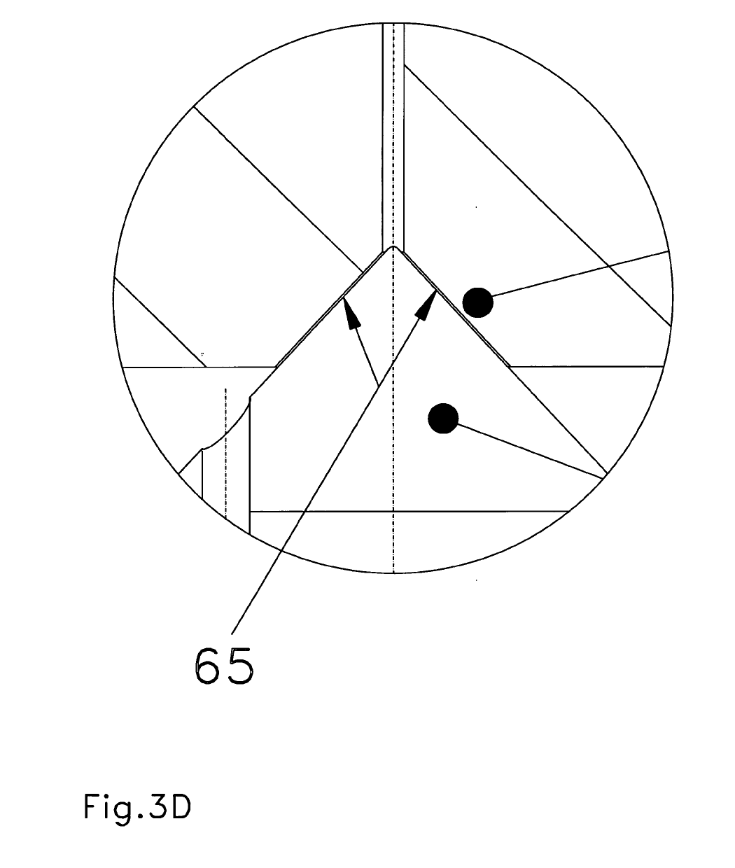

FIG. 3A shows the top of a piston rod 40 with a handle 2 and an electric pressure gauge 41. The gauge 41 is mounted on the handle 2. The piston rod 40 has an enclosed space 42 for keeping the piston pressurized. Said space can communicate with the piston (see e.g. WO2000/070227 or WO2002/077457 or WO2004031583). Pressurization to a desired level of the piston is done by an external pressure source (not shown) through an inflation nipple 43, which has an build in check valve 44. The exit hole 66 of the check valve 44. The nippel 43 is positioned at the bottom of the piston rod 40, and build in the head 45 of the bold 46. The enclosed measuring space 47 is build in a separate housing 48 in the head 45 of bolt 46. Said enclosed measuring space is connected through a check valve 49 with the measuring space 50. Said check valve is built in a separate housing 51. The (vertical) channel 52 is connected to the enclosed measuring space 47 within the tube 36.2 by means of a (horizontal) channel 53, and is sealed by a sealing means 54, e.g. an O-ring, in the enclosed measuring space 47. The cap 55, which is a part of the O-ring gland. Either is the transducer 15 mounted on the bottom 56 of the tube 57, where the channel 52 is filled in with a wire loom 57 to the electric pressure gauge 41, òr is the channel 52 open, and on top 58 of the channel 52, within the electric pressure gauge 41, is the transducer 15 mounted. Between the widened end 62 and the tapered end 63 is a very small space 64. It sets the flow from the channel 53.

FIG. 3B shows the bottom part of FIG. 3B on a scale 6:1.

FIG. 3C shows a part of the enclosed measuring space (47, 43, 52) on a scale of 6:1 in relation to FIG. 3B. The outlet channel 59 in the head 45 of the bold 46, with an screw 60, which sets the flow through the tiny channel 61 in the housing 48 of the enclosed measuring space 47. The channel 61 has a widened end 62, which suits the tapered end 63 of the screw 57. In the screw 60 a channel 64 connects the channel 61 with the outlet channel 59.

FIG. 3D shows a detail of FIG. 3C on a scale 5:1. The space 65 between the widened end 62 and the tapered end 63.

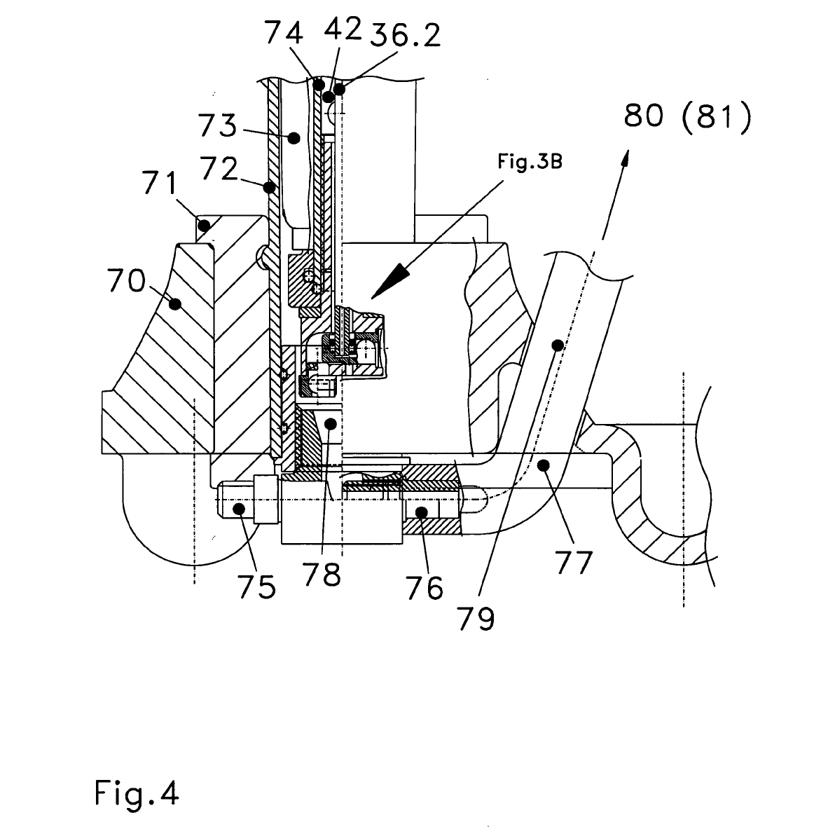

FIG. 4 shows the bottom part 70 of an advanced floor pump for e.g. tyre inflation. The flexible manchet 71 keeps the cone formed tube 72 in place. The inflatable piston 73. On the bottom of the piston rod 74 is the embodiment of FIGS. 3A-D mounted, without crew 57 arrangement (may only be necessary for prototyps). The enclosed space 42. The tube 36.2. The inlet check valve 75 The outlet check valve 76. The hose 77. The measuring space 78, 79 (inside the hose). The valve connector 80 (not shown). The space inside the valve connector 81 is also part of the measuring space (not shown).

### Measuring and Reading the Size of a Parameter of a Remotely Positioned Device

### Reference Numbers

1 piston rod FIG. 1A
2 handle FIG. 1A/2A/0
3 gauge FIG. 1A
4.1 upper space (of the enclosed space 8) FIG. 1A
4.2 bottom space (of the enclosed space 8) FIG. 1A
5 suspension (of the inflatable piston) FIG. 1A/1B/2A/2B
6 spring washer FIG. 1A/1B/2A/2B/0
7 bold FIG. 1A/1B/2A/2B/0
8 enclosed space (for the inflatable piston) FIG. 1A/1B/2A
9 valve body FIG. 1A/1B
10 nut FIG. 1A/1B/2A/2B
11 core pin FIG. 1A/1B
12 stem FIG. 1A/1B
13 housing FIG. 1A/1B/2A/2B
14 enclosed measuring space FIG. 1A/1B/2A/2B
15 transducer FIG. 1A/1B/0R
16 platform FIG. 1A/1B/0R
17 wall (of the measuring space) FIG. 1A/1B/2A/2B
18 valve FIG. 1A/1B/2A/2B
19 measuring space FIG. 1A
20 filler FIG. 1A
21 wiring loom FIG. 1A
22 transition FIG. 1A/0R
31 piston rod FIG. 2A
33 gauge FIG. 2A
34.1 space (upper part of the enclosed space 32) FIG. 2A
34.2 space (lower part of the enclosed space 32) FIG. 2A/2B
35 end FIG. 2A/2B
36.1 measuring channel FIG. 2A/2B
36.2 tube FIG. 2A/3B/4
37 top FIG. 2A
38 measuring space FIG. 2A
40 piston rod FIG. 3A/3B
41 electric pressure gauge FIG. 3A/3B
42 enclosed space FIG. 3A/3B/4
43 inflation nipple FIG. 3A/3B
44 check valve FIG. 3A/3B
45 head FIG. 3A/3B
46 bold FIG. 3A/3B
47 enclosed measuring space FIG. 3A/3B
48 housing FIG. 3A/3B
49 check valve FIG. 3A/3B
50 measuring space FIG. 3A/3B
51 housing FIG. 3A/3B
52 channel FIG. 3A/3B
53 channel FIG. 3A/3B
54 sealing means FIG. 3A/3B
55 cap FIG. 3A/3B
56 bottom FIG. 3A/3B
57 wire loom FIG. 3A/3B
58 top FIG. 3A/3B
59 outlet channel FIG. 3C
60 screw FIG. 3C
61 channel FIG. 3C
62 widened end FIG. 3C
63 tapered end FIG. 3C
64 channel FIG. 3C
65 space FIG. 3D
66 outlet hole FIG. 3A/3B
70 bottom part FIG. 4
71 manchet FIG. 4
72 tube FIG. 4
73 piston FIG. 4
74 piston rod FIG. 4
75 inlet check valve FIG. 4
76 outlet check valve FIG. 4
77 hose FIG. 4
78 measuring space FIG. 4
79 measuring space FIG. 4
80 valve connector FIG. 4
81 space FIG. 4
100 reading point FIG. 0L
101 housing FIG. 0L
102 manometer FIG. 0L
103 piston rod FIG. 0L
104 channel FIG. 0L
105 top FIG. 0L
106 bottom FIG. 0L
107 measuring channel FIG. 0L
108 measuring point FIG. 0L
109 suspension FIG. 0L
110 suspension FIG. 0L
111 measuring space FIG. 0L
112 suspension FIG. 0L
113 tube FIG. 0L
120 reading point FIG. 0R
121 housing FIG. 0R
122 gauge FIG. 0R
123 piston rod FIG. 0R
124 channel FIG. 0R
125 wire loom FIG. 0R
126 top FIG. 0R
127 bottom FIG. 0R
128 measuring point FIG. 0R
129 suspension FIG. 0R
130 measuring space FIG. 0R

1-37. (canceled)

38. A piston chamber combination comprising:
a piston in a chamber with a fluid exit and a sensor-reader combination with a sensor for measuring a parameter;
wherein the sensor is arranged to measure the parameter in a measuring space before the fluid exit of the chamber.

39. The piston chamber combination according to claim 38, wherein the fluid exit is provided with a check valve.

40. The piston chamber combination according to claim 38, wherein the sensor is located in an enclosed measuring space in the piston.

41. The piston chamber combination according to claim 40 further comprising a check valve between the enclosed measuring space and the chamber.

42. The piston chamber combination according to claim 40, wherein the piston comprises a hollow piston rod enclosing the enclosed measuring space.

43. The piston chamber combination according to claim 40 further comprising a first channel connecting the enclosed measurement space to the chamber.

44. The piston chamber combination according to claim 43 further comprising a screw for adjusting flow through the first channel.

45. The piston chamber combination according to claim 44, wherein the screw has a tapered head matching a correspondingly widened end of the first channel; and
wherein a second channel runs through the head from the tapered side to an opposite side of the head.

46. The piston chamber combination according to claim 40, wherein the enclosed measuring space comprises an inlet and an outlet valve initiated electrically under the control of a computer.

47. The piston-chamber combination according to claim 38, wherein the sensor-reader combination comprises a pressure sensor selected from the group consisting of pneumatic or electric pressure gauges, analog or digital volt or current meters in combination with an electric or electronic sensor, and transducers connected with mechanical conducting devices to an analog or digital gauge.

48. The piston-chamber combination according to claim 38, wherein the sensor-reader combination comprises a temperature sensor.

49. The piston-chamber combination according to claim 38, wherein the piston-chamber combination is a pump comprising means for engaging the piston from a position outside the chamber and a fluid entrance connected to the chamber, the fluid entrance comprising a valve.

50. The piston-chamber combination according to claim 49, wherein the piston comprises a piston rod with a handle on top of the piston rod, and wherein the handle is provided with an electric or pneumatic pressure gauge.

51. Method of measuring pressure in a tire during pumping by using a pump with a piston in a chamber and with a fluid exit connected to a hose and a check valve between the fluid exit and the hose, wherein the tire pressure is measured indirectly by measuring the pressure in the chamber before the check valve, at least during a pump stroke when the piston is pushed into the chamber.

52. The Method according to claim 51, wherein the pressure is measured in an enclosed measuring space in the piston, and wherein the enclosed measuring space is connected to the chamber with an opening provided with a check valve that provides an open connection between the enclosed measuring space and the chamber when the piston is moved into the chamber during a pump stroke, and which closes off said-opening of the enclosed measuring space during a return-stroke.
